(19) United States
(12) Patent Application Publication
(10) Pub. No.: US 2025/0299066 A1
(43) Pub. Date: Sep. 25, 2025

(54) FEATURE-SPECIFIC ATTENTION ARRAYS FOR EVENT SEQUENCE CHARACTERIZATION

(71) Applicant: Capital One Services, LLC, McLean, VA (US)

(72) Inventors: Samuel SHARPE, Cambridge, MA (US); Christopher Bayan BRUSS, Washington, DC (US); Senthil KUMAR, Marlboro, NJ (US); Doron BERGMAN, McLean, VA (US)

(73) Assignee: Capital One Services, LLC, McLean, VA (US)

(21) Appl. No.: 18/609,947

(22) Filed: Mar. 19, 2024

(51) Int. Cl. G06N 5/022

(52) U.S. Cl. CPC G06N 5/022

(57) ABSTRACT

A method and related system for efficiently capturing relationships between event feature values in embeddings includes flattening an event sequence into a feature sequence including a first event prefix, a second event prefix, and a first set of feature values. The method includes generating an attention mask including first mask indicators to associate the first set of feature values with each other and second mask indicator to associate a first feature value of the first set of feature values with the second event prefix. The method includes providing the feature sequence and the attention mask to a self-attention neural network model to generate an embedding.

### SUMMARY

In the field of machine learning, transformer models have become a powerful tool useful in a wide variety of applications, such as natural language processing, computer vision, time-series analysis, etc. Transformer models offer the benefit of detecting dependencies across multiple items in a sequence, can capture changes along a longer time span, and can be used in parallel without the use of expensive recurrent layers. One of the major aspects of transformer models that enable these benefits is the self-attention mechanism of the transformer model. The self-attention mechanism can allow different elements of an input sequence to provide additional context to the transformer model when the transformer model generates an output based on the input sequence.

Despite the advantages of a transformer model, a transformer model may suffer from either an underuse of data provided in an input sequence or an overabundance of data in the input sequence. For example, an input sequence may include a sequence of events, where each event may be characterized by one or more feature values. A naïve attempt to capture all events may include simply flattening the sequence of events such that all features of the event are included in the sequence. However, such an attempt is likely to escalate computing resource use to an unsustainable amount because the computational complexity of the self-attention mechanism of a transformer model scales quadratically with sequence length. Furthermore, attempts to capture feature data of an event sequence that involves encoding these events into an embedding space will incur additional computing costs related to training and data management. Additionally, the conversion of event data into an embedding space may decrease the ability to explain downstream results.

Some embodiments may overcome the technical issue described above by using a new type of attention array that captures relationships between features of different events. Some embodiments may retrieve a table or other multi-dimensional collection of temporal data, such as a sequence of events associated with a user. Each of these events may be categorized with an event type category and may further be characterized with additional feature information, such as a date, an amount, or another category, and some embodiments may then flatten the sequence of events into a sequence of sub-events, where the sub-events may be feature values of an event. After flattening the sequence of events into a sub-event sequence, some embodiments may generate an attention mask that intelligently associates events with each other for a self-attention machine learning model. The attention mask may include a first set of association indicators that, for each respective event represented by a flattened sub-event sequence, associates each sub-event value of the respective event with the other sub-event values of the same respective event. The attention mask may also include a second set of association indicators that associates events with other events, such as by associating each event prefix of a sub-event sequence with other event prefixes of the sub-event sequence. The attention mask may also include a third set of association indicators that associates sub-event values of an event with other sub-event values of other events.

Some embodiments may then provide this attention mask and the flattened sequence to a self-attention machine learning model to generate an embedding representing the event sequence. In the case where the event sequence represents events performed by or in association with a user, the embedding may be a representation of the user's event history. The various sets of association indicators of the attention mask may cause the self-attention machine learning model to generate corresponding attention weights influencing the output for a sub-event value of an event, where the attention weights may be based on the values of other sub-event values in the same event, values assigned to other events (e.g., event values represented by the event assigned to a prefix), or sub-event values assigned to other events. Some embodiments may then use the resulting embedding to predict a future outcome associated with the user and to act in response to this prediction. For example, after first generating an embedding for a user using the operations described above and then receiving a communication attempt from a user, some embodiments may provide the embedding and data related to the communication attempt to a prediction model to categorize with an action category. Some embodiments may then retrieve contextual information from a user-related profile to display on a web application of the user based on the action category.

Various other aspects, features, and advantages will be apparent through the detailed description of this disclosure and the drawings attached hereto. It is also to be understood that both the foregoing general description and the following detailed description are examples and not restrictive of the scope of the invention.

### BRIEF DESCRIPTION OF THE DRAWINGS

Detailed descriptions of implementations of the present technology will be described and explained through the use of the accompanying drawings.

FIG. 1 illustrates a system for using attention arrays associated with event properties to pre-retrieve user-related data, in accordance with some embodiments.

FIG. 2 illustrates a conceptual diagram of an architecture for using attention arrays corresponding with event properties of different events to prepare a dataset, in accordance with some embodiments.

FIG. 3 illustrates a conceptual diagram of a system for determining an attention array, in accordance with some embodiments.

FIG. 4 is a flowchart of a process for using attention arrays associated with event properties to pre-retrieve user-related data, in accordance with one or more embodiments.

The technologies described herein will become more apparent to those skilled in the art by studying the detailed description in conjunction with the drawings. Embodiments of implementations describing aspects of the invention are illustrated by way of example, and the same references can indicate similar elements. While the drawings depict various implementations for the purpose of illustration, those skilled in the art will recognize that alternative implementations can be employed without departing from the principles of the present technologies. Accordingly, while specific implementations are shown in the drawings, the technology is amenable to various modifications.

### DETAILED DESCRIPTION

In the following description, for the purposes of explanation, numerous specific details are set forth in order to provide a thorough understanding of the embodiments of the invention. It will be appreciated, however, by those having skill in the art that the embodiments of the invention may be practiced without these specific details or with an equivalent arrangement. In other cases, well-known structures and devices are shown in block diagram form in order to avoid unnecessarily obscuring the embodiments of the invention.

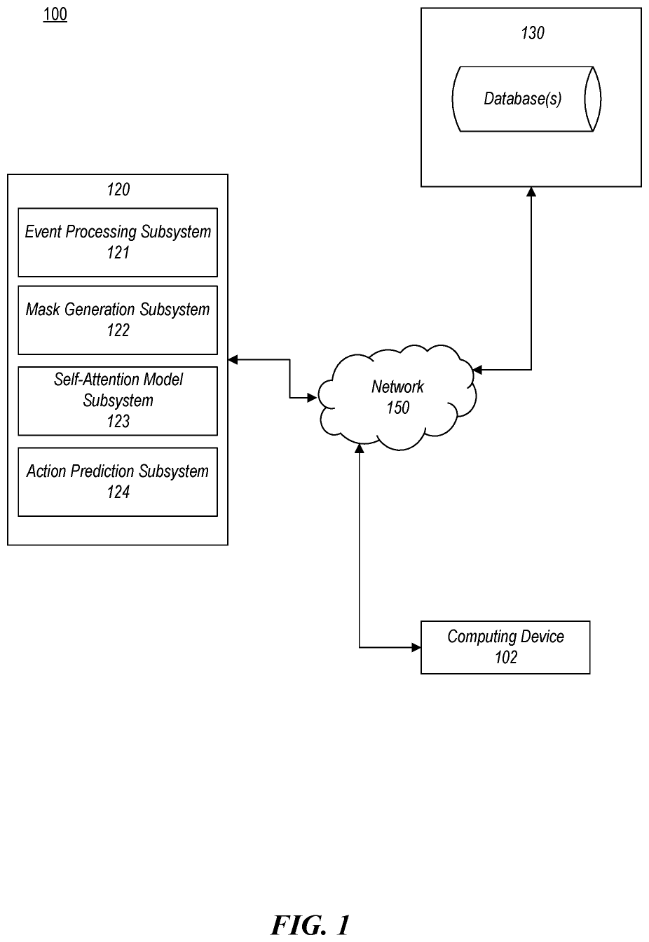

FIG. 1 illustrates a system for using attention arrays associated with event properties to pre-retrieve user-related data, in accordance with some embodiments. The system 100 includes a computing device 102. The computing device 102 may include computing devices such as a desktop computer, a laptop computer, a wearable headset, a smartwatch, another type of mobile computing device, a transaction device, etc. In some embodiments, the computing device 102 may communicate with various other computing devices via a network 150, where the network 150 may include the internet, a local area network, a peer-to-peer network, etc. The computing device 102 may send and receive messages through the network 150 to communicate with a first set of servers 120 within a first data center region, where the first set of servers 120 may include a set of non-transitory storage media storing program instructions to perform one or more operations of subsystems 121-124.

While one or more operations are described herein as being performed by particular components of the system 100, those operations may be performed by other components of the system 100 in some embodiments. For example, one or more operations described in this disclosure as being performed by the first set of servers 120 may instead be performed by the computing device 102. Furthermore, some embodiments may communicate with an application programming interface (API) of a third-party service via the network 150 to perform various operations disclosed herein. For example, some embodiments may provide a flattened feature sequence to an API and a self-attention mask to a computing service.

In some embodiments, the set of computer systems and subsystems illustrated in FIG. 1 may include one or more computing devices having electronic storage or otherwise capable of accessing electronic storage, where the electronic storage may include the set of databases 130. The set of databases 130 may include values used to perform operations described in this disclosure. For example, the set of databases 130 may store messages from computing components, self-attention masks, event sequences or other event data, etc.

In some embodiments, an event processing subsystem 121 may process input events to generate a flattened sequence of feature values. An event may include a set of feature values that characterize the event. For example, an event may be a transaction event, where a set of feature values of the transaction event includes an amount, a transaction sender, and a transaction receiver.

A sequence of events may be described as a multi-dimensional event sequence in the context of each event having multiple features. Some embodiments may use the event processing subsystem 121 to flatten the event sequence such that the entire event sequence is represented as a one-dimensional array. For example, some embodiments may use the event processing subsystem 121 to flatten a first multi-dimensional event sequence “[[A, a1, a2], [B, b1, b2, b3], [E, e1, e2]],” where each event includes an event prefix representing a category of the event or an identifier of the event, and where the other values of an event (e.g., “a1,” “a2,” “b1,” etc.) are features of that event. In some embodiments, the flattened version of the first multi-dimensional event sequence may include the one-dimensional feature sequence “[A, a1, a2, B, b1, b2, b3, E, e1, e2].” As described elsewhere, by flattening an event sequence into a feature sequence, some embodiments may prepare a self-attention neural network model to incorporate greater detail about feature values over time.

In some embodiments, a mask generation subsystem 122 may generate one or more attention masks storing cross-event mask indicators. A mask indicator may include a numerical value representing a relationship between two components of a sequence or another type of value indicating an association between two components of the sequence (e.g., a binary value, a categorical value, etc.). The mask generation subsystem 122 may generate one or more types of attention masks. For example, some embodiments may generate an attention mask that includes first attention mask indicators that link features with each other for the same event and link event prefixes of each event with each other. Alternatively, or additionally, the mask generation subsystem 122 may generate a cross-event attention mask that includes second attention mask indicators that associate the event prefix of each respective event with the event prefixes and event features of other events. Alternatively, or additionally, the mask generation subsystem 122 may generate a cross-event attention mask that further includes a window such that features of neighboring events are linked with each other. In many cases, the mask generation subsystem 122 may avoid generating an attention mask that associates all feature values with all other feature values to avoid basing a prediction on a fully interrelated sequence. Thus, though the mask generation subsystem 122 may generate various types of masks, at least one of these masks is generated such that feature values of at least one event are not indicated to have cross-event mask indicators linking the feature values to another event.

In some embodiments, a self-attention model subsystem 123 may use one or more of the attention masks described in this disclosure in combination with a feature sequence described in this disclosure to generate a vector representation of a user. Some embodiments may provide both an attention mask and an event feature sequence that includes a set of feature values to a self-attention transformer model or another self-attention neural network model. For example, some embodiments may provide a 100×100 self-attention mask and a 100-element feature sequence to a transformer model to generate a user embedding (e.g., a user vector) that can be used to form future predictions about user behaviors based on future user activity. The transformer model may compute an initial set of attention scores based on the feature sequence and apply the attention mask to the initial set of attention scores to modify the attention scores. The transformer model may then normalize the modified attention scores to determine a set of attention weights. Some embodiments may use an attention mask to modify the initial set of attention scores such that a corresponding set of attention weights includes first attention weights that associate feature values of an event with other feature values of the same event. In some embodiments, the attention mask may also include attention indicators linking feature values with event prefixes such that a corresponding set of attention weights of a self-attention neural network model includes second attention weights that associate feature values with other event prefixes representing other events.

In some embodiments, an attention mask used to generate a user embedding may include attention values of attention masks associating feature values of an event with each other may implicitly affect the vector representation such that intra-event feature relationships may be encoded into the vector representation. For example, the attention mask may include attention indicators that associate an event prefix with other event prefixes. Furthermore, the attention values of attention masks associating feature values of different events may implicitly affect the vector representation such that inter-event feature relationships may be encoded into the vector representation. The vector representation may be used as a user embedding to represent an encoded version of a user's event history.

In some embodiments, an action prediction subsystem 124 may predict one or more future action categories or other types of predicted values based on a vector representation of a user. For example, the action prediction subsystem 124 may obtain new event data associated with a user and a vector representation of the user. The action prediction subsystem 124 may then generate a predicted value with a transformer neural network based on the vector representation and the new event data. The feature value may be useful to indicate a user's intended actions. To prepare to execute this set of intended actions, some embodiments may prepare an application context by retrieving a set of user-related profile data or another set of user data for display on an application (e.g., a web application). For example, some embodiments may obtain a user embedding for a user and provide the user embedding to the action prediction subsystem 124 to predict a future action category indicating that a user plans to ask a chatbot about their account settings. Some embodiments may then retrieve a user's username, a user's account number, and a user's address based on the future action category and present the retrieved information in a web application, where the web application is presented to at least one of the user or an agent in communication with the user.

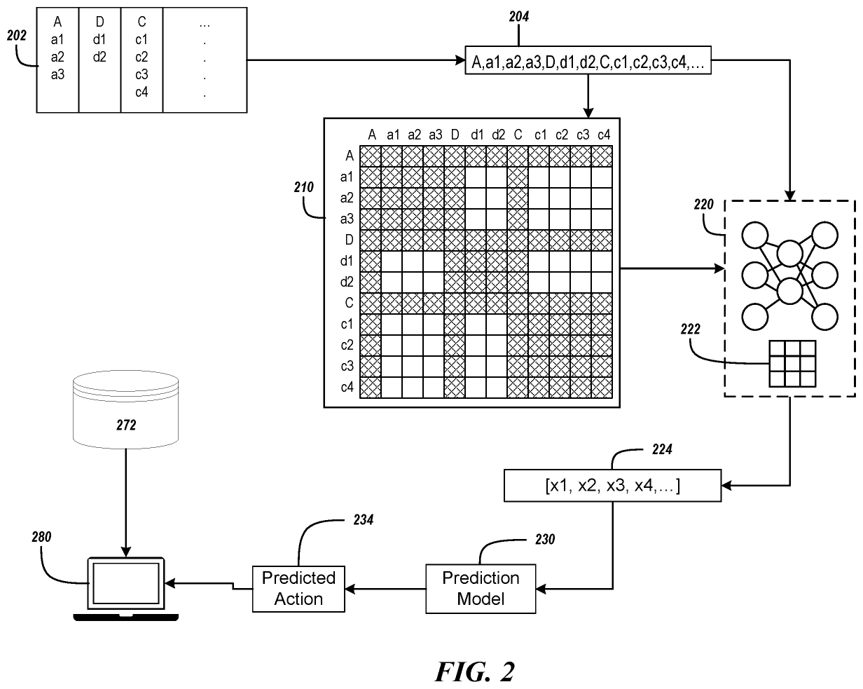

FIG. 2 illustrates a conceptual diagram of an architecture for using attention arrays corresponding with event properties of different events to prepare a dataset, in accordance with some embodiments. Some embodiments may flatten a multi-dimensional event sequence 202 into a flattened feature sequence 204. Some embodiments may use a mask generator to generate an attention mask 210. As shown in FIG. 2, the attention mask 210 indicates a set of associations between each respective event prefix “A,” “D,” and “C” and the other event prefixes. Furthermore, each respective event feature is shown as being associated with the other event features of its own event. For example, event feature “a1” is shown as being associated with “a2” and “a3.” Additionally, each respective event feature is shown as being associated with other event prefixes of other events. For example, the event feature “a1” is shown as being associated with the event prefix “D” and the event prefix “C.”

Some embodiments may provide the flattened feature sequence 204 and the attention mask 210 to a self-attention neural network 220. The self-attention neural network 220 may then determine an initial set of attention scores based on the flattened feature sequence 204 and then use the attention mask 210 to determine a set of attention weights 222. The set of attention weights may be constructed such that, when represented as an array, elements that are represented by zero in the attention mask 210 are also represented by zero in the set of attention weights 222. For example, if a first element of the attention mask 210 is represented by a first array element that is positioned at the i-th row and the j-th column, a nonzero value for the first array element may result in a second element of the set of attention weights 222 also at the i-th row and the j-th column being determined as a nonzero value. Some embodiments may use the self-attention neural network 220 having the set of attention weights 222 to determine a user embedding 224.

In some embodiments, a prediction model 230 may obtain the embedding 224 to determine a predicted action 234. In some embodiments, the predicted action 234 may represent a category indicating a likely user intent or otherwise correlated with a most likely set of actions to be performed by the user. Some embodiments may prepare an environment to accommodate the user intent or set of planned operations. For example, some embodiments may receive a call from a user, where the call and information related to the call may be treated as a new event. Some embodiments may provide the new event information in combination with the embedding 224 to the prediction model 230 to determine a predicted value indicating that a user will request customer service support regarding an additional payment. Some embodiments may then retrieve user-related data associated with the additional payment from a database 272 and present the user-related data on a user interface (UI) of a web application executing on a computing device 280 that is being used by a customer support user.

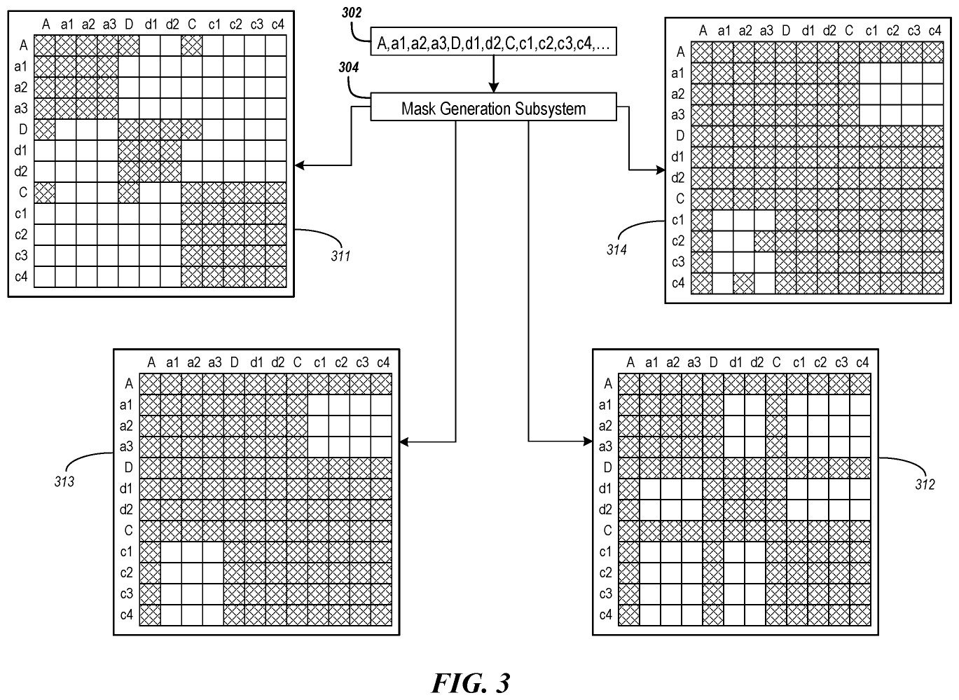

FIG. 3 illustrates a conceptual diagram of a system for determining an attention mask, in accordance with some embodiments. Some embodiments may perform operations described in this disclosure to generate a flattened feature sequence 302. The flattened feature sequence may include values from events, such as a first event, a second event, and a third event. The portion of the flattened feature sequence 302 representing the first event includes a feature prefix “A” (representing an event category “A”) and a set of feature values “a1,” “a2,” and “a3.” The portion of the flattened feature sequence 302 representing the second event includes a feature prefix “D” (representing an event category “D”) and a set of feature values “d1” and “d2.” The portion of the flattened feature sequence 302 representing the third event includes a feature prefix “C” (representing an event category “C”) and a set of feature values “c1,” “c2,” “c3,” and “c4.”

Some embodiments may provide the flattened feature sequence 302 to a mask generator 304. In some embodiments, the fourth attention mask 314 may be configured to generate one of multiple types of attention masks, such as the first attention mask 311, a second attention mask 312, a third attention mask 313, and a fourth attention mask 314. Each of the attention masks 311-314 are shown as a race, where the crosshatched boxes represent nonzero values (e.g., “1”), and where the empty boxes represent zero values. A nonzero value in an attention array indicates that the elements corresponding with that role and column are related with each other with respect to a self-attention neural network.

For example, some embodiments may generate the first attention mask 311, where elements of the attention mask 311 indicate that event prefixes are associated with each other and that feature values of the same event are also associated with each other. Some embodiments may be configured to use the first attention mask 311 to determine user embeddings in cases where computing resources are most limited. By allowing events to be related only via their prefixes, some embodiments may reduce the total amount of computation required to generate a user embedding.

Some embodiments may be configured to use the mask generator 304 to generate the second attention mask 312. The second attention mask 312 includes all of the nonzero mask indicators of the first attention mask 311 and further includes nonzero mask indicators for elements relating event prefixes with individual feature values. By directly relating feature values to other events, some embodiments provide a path for embedding-based decision models to consider relationships between individual feature values and other events. This level of data richness may provide a means for embedding data to capture behavior patterns that may have gone otherwise undetected.

Some embodiments may be configured to use mask generator 304 to generate the third attention mask 313. The third attention mask 313 includes all of the nonzero mask indicators of the second attention mask 312 and further includes nonzero mask indicators for elements relating feature values with other feature values of adjacent events. By directly relating feature values with other feature values, some embodiments may strengthen the possibility of capturing predictive power in the specific relationships between different feature values over time. This level of detail may be especially useful in cases where events themselves do not hold predictive power but specific patterns of behavior across events may provide insight into a user's behavior.

Some embodiments may be configured to use the mask generator 304 to generate the fourth attention mask 314. The fourth attention mask 314 includes all the nonzero mask indicators of the third attention mask 313 and further includes nonzero mask indicators for elements relating feature values at random. By using randomly determined nonzero mask indicators in addition to other mask indicators described in this disclosure, some embodiments may perform automated experimentation. Such experimentation may provide opportunities to further detect predictive power in associations between different feature values of different elements that are not necessarily adjacent.

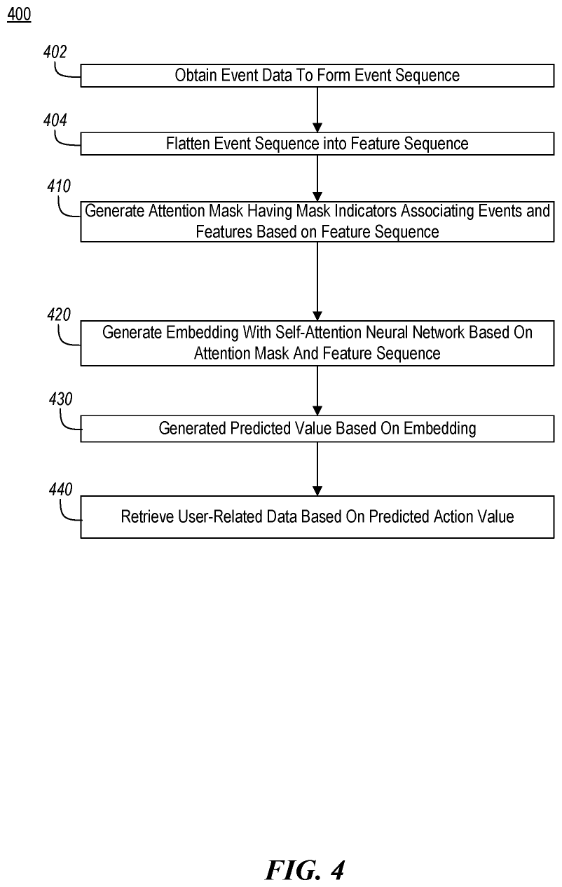

FIG. 4 is a flowchart of a process 400 for using attention arrays associated with event properties to pre-retrieve user-related data, in accordance with one or more embodiments. Some embodiments may obtain event data to form an event sequence, as indicated by block 402. Some embodiments may obtain event data directly from a user interaction that generates an event record. Alternatively, or additionally, some embodiments may obtain event data from user interactions with third-party devices, such as kiosks, merchant terminals, or third-party computing devices. Alternatively, or additionally, some embodiments may obtain event data from user records, databases of past transactions, etc. Some embodiments may sort the event data based on a timestamp or other time data associated with the event data to determine an event sequence.

As described elsewhere, some embodiments may use original or normalized event data as inputs for mask generation. For example, some embodiments may obtain transaction event data with the form [type: “T”, val1: t1, val2: t2, val3: “t3-val3”]. Some embodiments may then directly use “T,” t1, t2, and “t3-val3” as values of an event sequence. Alternatively, some embodiments may apply an encoder model to event data to transform the event data into an event embedding space. For example, some embodiments may use a neural network encoder to convert transaction event data into an encoded version having fewer dimensions than the unencoded transaction event data.

Some embodiments may filter the event sequence to remove certain types of events to satisfy one or more technical or non-technical requirements. For example, some embodiments may obtain instructions to remove all data corresponding with transactions of a particular type. Some embodiments may then filter one or more events used to form an event sequence to remove a set of events from an event sequence based on the instructions. For example, some embodiments may filter events based on a time criteria, such as a threshold date. After obtaining a set of events, some embodiments may filter the events to remove a subset of the events that occurred before a threshold date. Alternatively, or additionally, some embodiments may filter event data based on other criteria, such as including events occurring within a target time-of-day interval, including events that occurred within a pre-configured duration, including events that are of a target event type, etc.

Some embodiments may flatten an event sequence into a feature sequence, as indicated by block 404. Some embodiments may obtain event data used to form an event sequence. Event data may characterize one or more types of events that can be associated with a specific time or duration. Some embodiments may represent an event with an event prefix and a set of feature values, where the event prefix may be represented by a category characterizing the nature of the event, and where the set of feature values may characterize aspects of the event. For example, an event may be represented by a sequence of values that starts with the event prefix “P” and is followed by a first feature value “0.31,” a second feature value “xjl206,” and a third feature value “1.5.” It should be understood that different features correspond with different types of events. For example, some events may have feature values that are all numeric values. Alternatively, or additionally, some events may have feature values that are text, representations of categories, or other data types.

As described elsewhere in this disclosure, some embodiments may use a self-attention model on input data to determine a user embedding. In some embodiments, the event data may be transformed into an embedding space before being used. Alternatively, some embodiments may be free from requirements to transform the events into embeddings. For example, some embodiments may obtain events of the event sequence and flatten the event sequence without generating embeddings based on the events or other event vector representations of the events. By flattening an event sequence for later use as an input for user embedding generation without generating one or more event vector representations of the events, some embodiments may avoid computationally onerous operations to train an encoder to generate event embeddings or use a trained encoder.

Some embodiments may generate an attention mask that includes mask indicators associating events and features based on the feature sequence, as indicated by block 410. Some embodiments may generate a mask that associates feature values of different events with each other. For example, some embodiments may generate a mask linking different feature values of different events, where the mask includes a mask indicator that associates a feature value of a first event with a feature value of a second event. In some embodiments, the events may be different with respect to each other. For example, if a feature sequence starts with the segment “T, t1, t2, t3, B, b1, b2 . . . ,” an attention array representing an attention mask may include a mask indicator that associates t1 with b1 by including a first nonzero element at the position [1, 5] (i.e., relating the “t1” position with the “b1” position) and a second nonzero element at the position [5, 1] (i.e., relating the “b1” position with the “t1” position). As described elsewhere, by directly linking feature values of different events, richer relationships between features of different elements can be captured.

Some embodiments may obtain instructions or other data that indicates an association between different features of different events. For example, some embodiments may obtain a set of inter-event mapping indications that maps a feature type of a first event type to a feature type of a second event type. For example, some embodiments may receive a set of linked event type identifiers that indicates that all features of events categorized as “transaction” should be linked to all features of events categorized as “web application sign-in.”

Alternatively, or additionally, some embodiments may receive a set of linked feature type identifiers that indicates that specific features of different events should be linked with each other without requiring that all features of the different events should be linked with each other. For example, when determining a set of mask indicators for a first feature value of a first event, some embodiments may determine that a second feature value of a different event is of a target feature type. In response, some embodiments may generate the set of mask indicators to associate the first and second feature values. For example, some embodiments may receive a set of linked feature type identifiers that indicates that feature values corresponding with the feature type “amount” of events categorized with the category “transaction” should be linked with feature values corresponding with the feature type “login reset indicator” of events categorized as “web application login.” After receiving the set of linked feature type identifiers, some embodiments may generate a mask that associates feature values that (1a) correspond with the feature type “amount” and (1b) are values of events of the event type “transaction” with all feature values that (2a) correspond with the feature type “login reset indicator” and (2b) are values of events of the event type “web application login.”

Alternatively, or additionally, some embodiments may determine that feature values of different events should be associated with each other based on other types of feature-related criteria. A set of feature-related criteria may include a criterion that both features occurred within a same duration. Alternatively, or additionally, the set of feature-related criteria may include a criterion that a sequentially first feature is a feature of a first pre-determined feature type or is a feature of an event of a first required event type and a sequentially second feature. For example, some embodiments may flatten a sequence of events into a feature sequence “[A, a11, a12, B, b11, b12, F, f11, f12, f13, A, a21, a22, . . . ].” Some embodiments may then apply a set of feature-related criteria to the feature sequence, where the set of feature-related criteria includes a criterion that feature values of a feature type corresponding with “a12” that are before feature values of a feature type corresponding with “f12” should be related with each other. In applying this set of feature-related criteria, some embodiments may generate an attention mask having an indicator that associates the feature values “a12” with “f12.”

Alternatively, or additionally, some embodiments may generate a mask that includes mask indicators which associate feature values to events based on an event type. For example, some embodiments may generate an attention mask that includes a feature-to-event mapping indication that associates a feature type of a first event type to feature values or event prefixes of other events based on a determination that the other events satisfy a target event type. For example, some embodiments may determine whether a feature value corresponding with the feature type “destination” of the event type “transportation” should be associated with a set of feature values based on whether the set of feature values are features of an event having the event type “registration.” Based on a determination that the set of feature values are feature values of a first event having the event type “registration,” some embodiments may associate “destination” with that set of feature values when generating an attention mask.

When associating feature values of an event with event prefixes or feature values of other events, some embodiments may use an attention window to determine which feature values to associate with other feature values of different events. An attention window may be retrieved from one or more various types of data sources. For example, some embodiments may obtain an attention window from a configuration file, user input, or other source of information.

In some embodiments, the attention window may indicate an event adjacency range of feature values to associate with each other. An event adjacency range may indicate the degree in which two events (or features of those events) are considered as being related to each other when ordered in an event sequence. Some embodiments may use the attention window to determine the range of neighboring events with which to associate features with each other. For example, some embodiments may obtain an attention window representing an event adjacency range equal to one and, in response, assign all features of the nearest consecutive events with each other. Alternatively, some embodiments may obtain an event adjacency range equal to two and assign all feature values of an event with all feature values of both the nearest consecutive events and second-nearest consecutive events.

In some embodiments, an attention window may be based on time, such as a look-back duration. For example, some embodiments may relate event prefixes and event feature values of different events with each other based on whether the different events occurred within a pre-configured look-back duration. When determining a set of mask indicators for each respective feature value the event sequence, some embodiments may determine a number of other feature values or other feature prefixes to associate with the respective feature value. For example, some embodiments may obtain an event sequence represented by “[A, a11, a12, B, b11, b12, F, f11, f12, f13, A, a21, a22, . . . ]” and a look-back duration equal to five days, where the event prefixes “A,” “B,” and “F” may represent event categories. Some embodiments may then determine, for the feature value “a21,” which of the other feature values to associate with the feature value “a21” by first determining that a third event represented by the segment “[F, f11, f12, f13]” and a second event represented by the segment “[B, b11, b12]” occurred within the five-day look-back duration, and that a first event represented by the segment [A, a11, a12] did not occur within the five-day look-back duration. In response to this determination, some embodiments may generate a mask having indicators that associate feature values and feature prefixes of the second event and third event with the feature value “f21” without associating feature values and feature prefixes of the first event.

In some embodiments, an attention window may be set based on a number of layers of the self-attention neural network model. By determining an attention window based on the layers of a self-attention model, some embodiments may increase performance and operational speed of a machine learning model. For example, some embodiments may determine that a count of neural network layers of a self-attention neural network model used to generate a user embedding is a value between “3” and “6.” Some embodiments may then determine an attention window as being between “1” and “4” based on the number of neural network layers and a configuration function that sets the attention window size to be an event adjacency range equal to “7-N,” where N is the count of neural network layers. Alternatively, an attention window may represent a look-back duration or other measure of time. Some embodiments may increase the length of the look-back duration or other measure of time in response to a decrease in the number of layers of the self-attention neural network model.

Some embodiments may randomly generate one or more indicators of the association indicators of an attention mask related to associating two feature values with each other. For example, some embodiments may generate a set of random values using a physics-based system or a pseudorandom process. Some embodiments may then use the random values to select one or more mask indicators that associate feature values of a first event with other feature values of another event or an event prefix of the other event. For example, some embodiments may determine a set of zero-value elements in an attention array, randomly select a subset of the zero-value elements, and replace the subset of zero-value elements with one or more nonzero values. By randomly generating some or all of the indicators of an attention mask, some embodiments may explore new relationships between features or events that may have gone undetected in other mask regimes.

When generating a set of attention masks, some embodiments may generate multiple attention masks based on a shared feature sequence. Some embodiments may compare masks with each other with respect to their performance as a function of differences in the policies used to determine feature-to-feature associations in the masks. For example, some embodiments may generate a first attention mask that associates event prefixes with other event prefixes and with feature values of adjacent events. Some embodiments may also generate a second attention mask that associates event prefixes with other event prefixes, associates event prefixes with feature values of adjacent events, and further associates feature values with the feature values of adjacent events. As described elsewhere in this disclosure, some embodiments may then generate different user embeddings or other embeddings based on the different attention masks and later use the different embeddings to predict different action category values or generate another type of predicted value. Some embodiments may then obtain a feedback value indicating which of the predicted values is more accurate and select the mask associated with greater accuracy based on the feedback value.

Some embodiments may prevent attention weights from being made for a specified type of event. For example, some embodiments may obtain a set of event association filters indicating a restricted event type that should not be associated with other events, where a restricted event type may include a restricted event category, a restricted feature value for the event, some combination thereof, etc. Some embodiments may use this information to set, as zero, elements of an attention mask corresponding with event prefixes or feature values of events of the restricted event type. For example, some embodiments may obtain an event association filter that indicates that transaction events having a feature value equal to “card1” for the feature type “card used” are restricted. In response, some embodiments may set event prefixes and event feature values of the transaction events from being associated with other event prefixes or other event features. Alternatively, or additionally, some embodiments may prevent attention weights from being made for a specified type of feature. For example, some embodiments may prevent an age-related feature value for the feature type “age” from being associated with other feature values by setting a set of mask indicators indicating associations between the age-related feature value and other feature values to zero. Setting the set of mask indicators to zero may cause self-attention models ignore event prefixes and feature values associated with the restricted event type, causing attention weights corresponding with the restricted event types to be zero. By preventing attention weights from being formed for target events, some embodiments may prevent known counterproductive relationships or known prohibited relationships from being encoded in an embedding. For example, a prohibition on relating age with other factors may be avoided by preventing associations between age-related feature values and other feature values of a feature sequence.

Some embodiments may generate an embedding with a self-attention neural network model based on the attention mask and the feature sequence, as indicated by block 420. For example, some embodiments may provide a feature sequence to a self-attention neural network as an input. The self-attention neural network may act as a set of embedding layers and assign each element of the feature sequence with a vector representation to generate a sequence of embeddings. Some embodiments may then apply an attention mask described in this disclosure, where applying the attention mask may include performing element-wise multiplication operations based on the attention mask with the sequence of embeddings. Some embodiments may then pass the masked embeddings into additional layers of the self-attention neural network model, where the self-attention neural network model may include transformers. As described elsewhere in this disclosure, the attention array may cause outputs generated from a feature value of one event to be influenced by feature values of other events. Some embodiments may then use a final output of the self-attention neural network as a user embedding or other representation for a user or entity related to the feature sequence.

Some embodiments may generate a predicted value based on the embedding, as indicated by block 430. Various types of downstream operations may be performed based on an embedding that was generated using operations described in this disclosure. Some embodiments may first train a prediction model based on a training set of user embeddings and associated classifications. Some embodiments may then use the trained prediction model to classify a user based on a user embedding associated with the user. For example, some embodiments may train a neural network prediction model to predict whether a user is likely to seek assistance when contacting a phone number, where the prediction model is trained with a training set of user embeddings. Some embodiments may obtain an indication that a user has initiated a phone call and, in response, retrieve a user embedding for the user. Some embodiments may then predict that the user intends to initiate a transfer by providing the prediction model with the user embedding.

In some embodiments, a new embedding may be generated in real time with respect to a user action. For example, some embodiments may detect that a user has accessed a web application and collect information about a new event representing the user's current activities in the web application. Some embodiments may update an event sequence with the new event (e.g., by appending the new event to the event sequence) and perform operations described in this disclosure to generate an updated feature sequence, an updated mask, and an updated user embedding.

Some embodiments may retrieve user-related data based on the predicted value, as indicated by block 440. Some embodiments may retrieve user-related data associated with a predicted value. For example, some embodiments may predict an action category, where a respective action category of different action categories may correspond with a respective set of information or interfaces appropriate for that respective action category. In some embodiments, the user-related data may be presented to the user directly. For example, based on a determination that a user has accessed a web application and that the user is likely to request an asset deletion based on a prediction value that is determined using operations described in this disclosure, some embodiments may send instructions to the web application to load a particular interface with pre-populated data retrieved from the users profile. Alternatively, or additionally, data corresponding with a predicted value may be provided to another entity that may be in communication with the user. For example, based on a determination that a user has initiated a chat session with a chatbot, some embodiments may perform operations described in this disclosure to generate a prediction value indicating a category representing the user's intent. Based on the prediction value indicating that the user seeks information about a recent transaction, some embodiments may modify a context parameter or other parameter used by the chatbot. As another example, a user may initiate a communication session with a support analyst who is using their own web application to provide support to the user. Based on a prediction value generated from an event sequence representing events related to the user, where the prediction value indicates that a user is likely to want to reverse a set of transactions, some embodiments may update a UI of the web application being presented to the support analyst or send user-related data necessary to reverse the set of transactions.

As used in the specification and in the claims, the singular forms of “a,” “an,” and “the” include plural referents unless the context clearly dictates otherwise. In addition, as used in the specification and the claims, the term “or” means “and/or” unless the context clearly dictates otherwise. Additionally, as used in the specification, “a portion” refers to a part of, or the entirety (i.e., the entire portion), of a given item (e.g., data) unless the context clearly dictates otherwise. Furthermore, a “set” may refer to a singular form or a plural form, such that a “set of items” may refer to one item or a plurality of items.

In some embodiments, the operations described in this disclosure may be implemented in a set of processing devices (e.g., a digital processor, an analog processor, a digital circuit designed to process information, an analog circuit designed to process information, a state machine, and/or other mechanisms for electronically processing information). The processing devices may include one or more devices executing some or all of the operations of the methods in response to instructions stored electronically on a set of non-transitory, machine-readable media, such as an electronic storage medium. Furthermore, the use of the term “media” may include a single medium or combination of multiple media, such as a first medium and a second medium. A set of non-transitory, machine-readable media storing instructions may include instructions included on a single medium or instructions distributed across multiple media. The processing devices may include one or more devices configured through hardware, firmware, and/or software to be specifically designed for the execution of one or more of the operations of the methods. For example, it should be noted that one or more of the devices or equipment discussed in relation to FIGS. 1-2 could be used to perform one or more of the operations described in relation to FIGS. 3-4.

It should be noted that the features and limitations described in any one embodiment may be applied to any other embodiment herein, and a flowchart or examples relating to one embodiment may be combined with any other embodiment in a suitable manner, done in different orders, or done in parallel. Furthermore, not all operations of a flowchart need to be performed. For example, some embodiments may perform operations of block 430 without performing operations of block 440. In addition, the systems and methods described herein may be performed in real time. It should also be noted that the systems and/or methods described above may be applied to, or used in accordance with, other systems and/or methods.

In some embodiments, the various computer systems and subsystems illustrated in FIG. 1 or FIG. 2 may include one or more computing devices that are programmed to perform the functions described herein. The computing devices may include one or more electronic storages (e.g., a set of databases accessible to one or more applications depicted in the system 100), one or more physical processors programmed with one or more computer program instructions, and/or other components. For example, the set of databases may include a relational database such as a PostgreSQL™ database or MySQL database. Alternatively, or additionally, the set of databases or other electronic storage used in this disclosure may include a non-relational database, such as a Cassandra™ database, MongoDB™ database, Redis database, Neo4j™database, Amazon Neptune™ database, etc.

The computing devices may include communication lines or ports to enable the exchange of information with a set of networks (e.g., a network used by the system 100) or other computing platforms via wired or wireless techniques. The network may include the internet, a mobile phone network, a mobile voice or data network (e.g., a 5G or Long-Term Evolution (LTE) network), a cable network, a public switched telephone network, or other types of communications networks or combination of communications networks. A network described by devices or systems described in this disclosure may include one or more communications paths, such as Ethernet, a satellite path, a fiber-optic path, a cable path, a path that supports internet communications (e.g., IPTV), free-space connections (e.g., for broadcast or other wireless signals), Wi-Fi, Bluetooth, near field communication, or any other suitable wired or wireless communications path or combination of such paths. The computing devices may include additional communication paths linking a plurality of hardware, software, and/or firmware components operating together. For example, the computing devices may be implemented by a cloud of computing platforms operating together as the computing devices.

Each of these devices described in this disclosure may also include electronic storages. The electronic storages may include non-transitory storage media that electronically stores information. The storage media of the electronic storages may include one or both of (i) system storage that is provided integrally (e.g., substantially non-removable) with servers or client computing devices, or (ii) removable storage that is removably connectable to the servers or client computing devices via, for example, a port (e.g., a USB port, a firewire port, etc.) or a drive (e.g., a disk drive, etc.). The electronic storages may include one or more of optically readable storage media (e.g., optical disks, etc.), magnetically readable storage media (e.g., magnetic tape, magnetic hard drive, floppy drive, etc.), electrical charge-based storage media (e.g., EEPROM, RAM, etc.), solid-state storage media (e.g., flash drive, etc.), and/or other electronically readable storage media. The electronic storages may include one or more virtual storage resources (e.g., cloud storage, a virtual private network, and/or other virtual storage resources). An electronic storage may store software algorithms, information determined by the processors, information obtained from servers, information obtained from client computing devices, or other information that enables the functionality as described herein.

The processors may be programmed to provide information processing capabilities in the computing devices. As such, the processors may include one or more of a digital processor, an analog processor, a digital circuit designed to process information, an analog circuit designed to process information, a state machine, and/or other mechanisms for electronically processing information. In some embodiments, the processors may include a plurality of processing units. These processing units may be physically located within the same device, or the processors may represent the processing functionality of a plurality of devices operating in coordination. The processors may be programmed to execute computer program instructions to perform functions described herein of subsystems described in this disclosure or other subsystems. The processors may be programmed to execute computer program instructions by software; hardware; firmware; some combination of software, hardware, or firmware; and/or other mechanisms for configuring processing capabilities on the processors.

It should be appreciated that the description of the functionality provided by the different subsystems described herein is for illustrative purposes, and is not intended to be limiting, as any of the subsystems described in this disclosure may provide more or less functionality than is described. For example, one or more of subsystems described in this disclosure may be eliminated, and some or all of its functionality may be provided by other ones of subsystems described in this disclosure. As another example, additional subsystems may be programmed to perform some or all of the functionality attributed herein to one of the subsystems described in this disclosure.

With respect to the components of computing devices described in this disclosure, each of these devices may receive content and data via input/output (I/O) paths. Each of these devices may also include processors and/or control circuitry to send and receive commands, requests, and other suitable data using the I/O paths. The control circuitry may comprise any suitable processing, storage, and/or I/O circuitry. Further, some or all of the computing devices described in this disclosure may include a user input interface and/or user output interface (e.g., a display) for use in receiving and displaying data. In some embodiments, a display such as a touchscreen may also act as a user input interface. It should be noted that in some embodiments, one or more devices described in this disclosure may have neither user input interface nor displays and may instead receive and display content using another device (e.g., a dedicated display device such as a computer screen and/or a dedicated input device such as a remote control, mouse, voice input, etc.). Additionally, one or more of the devices described in this disclosure may run an application (or another suitable program) that performs one or more operations described in this disclosure.

Although the present invention has been described in detail for the purpose of illustration based on what is currently considered to be the most practical and preferred embodiments, it is to be understood that such detail is solely for that purpose and that the invention is not limited to the disclosed embodiments, but, on the contrary, is intended to cover modifications and equivalent arrangements that are within the scope of the appended claims. For example, it is to be understood that the present invention contemplates that, to the extent possible, one or more features of any embodiment may be combined with one or more features of any other embodiment.

As used throughout this application, the word “may” is used in a permissive sense (i.e., meaning having the potential to), rather than the mandatory sense (i.e., meaning must). The words “include,” “including,” “includes,” and the like mean including, but not limited to. As used throughout this application, the singular forms “a,” “an,” and “the” include plural referents unless the context clearly indicates otherwise. Thus, for example, reference to “an element” or “the element” includes a combination of two or more elements, notwithstanding the use of other terms and phrases for one or more elements, such as “one or more.” The term “or” is non-exclusive (i.e., encompassing both “and” and “or”), unless the context clearly indicates otherwise. Terms describing conditional relationships (e.g., “in response to X, Y,” “upon X, Y,” “if X, Y,” “when X, Y,” and the like) encompass causal relationships in which the antecedent is a necessary causal condition, the antecedent is a sufficient causal condition, or the antecedent is a contributory causal condition of the consequent (e.g., “state X occurs upon condition Y obtaining” is generic to “X occurs solely upon Y” and “X occurs upon Y and Z”). Such conditional relationships are not limited to consequences that instantly follow the antecedent obtaining, as some consequences may be delayed, and in conditional statements, antecedents are connected to their consequents (e.g., the antecedent is relevant to the likelihood of the consequent occurring). Statements in which a plurality of attributes or functions are mapped to a plurality of objects (e.g., a set of processors performing steps/operations A, B, C, and D) encompass all such attributes or functions being mapped to all such objects and subsets of the attributes or functions being mapped to subsets of the attributes or functions (e.g., both/all processors each performing steps/operations A-D, and a case in which processor 1 performs step/operation A, processor 2 performs step/operation B and part of step/operation C, and processor 3 performs part of step/operation C and step/operation D), unless otherwise indicated. Further, unless otherwise indicated, statements that one value or action is “based on” another condition or value encompass both instances in which the condition or value is the sole factor and instances in which the condition or value is one factor among a plurality of factors.

Unless the context clearly indicates otherwise, statements that “each” instance of some collection has some property should not be read to exclude cases where some otherwise identical or similar members of a larger collection do not have the property (i.e., each does not necessarily mean each and every). Limitations as to the sequence of recited steps should not be read into the claims unless explicitly specified (e.g., with explicit language like “after performing X, performing Y”) in contrast to statements that might be improperly argued to imply sequence limitations (e.g., “performing X on items, performing Y on the X'ed items”) used for purposes of making claims more readable rather than specifying a sequence. Statements referring to “at least Z of A, B, and C,” and the like (e.g., “at least Z of A, B, or C”), refer to at least Z of the listed categories (A, B, and C) and do not require at least Z units in each category. Unless the context clearly indicates otherwise, it is appreciated that throughout this specification discussions utilizing terms such as “processing,” “computing,” “calculating,” “determining” or the like refer to actions or processes of a specific apparatus, such as a special purpose computer or a similar special purpose electronic processing/computing device. Furthermore, unless indicated otherwise, updating an item may include generating the item or modifying an existing item. Thus, updating a record may include generating a record or modifying the value of an already-generated value in a record.

Unless the context clearly indicates otherwise, ordinal numbers used to denote an item do not define the item's position. For example, an item that may be a first item of a set of items even if the item is not the first item to have been added to the set of items or is otherwise indicated to be listed as the first item of an ordering of the set of items. Thus, for example, if a set of items is sorted in a sequence from “item 1,” “item 2,” and “item 3,” a first item of a set of items may be “item 2” unless otherwise stated.

The present techniques will be better understood with reference to the following enumerated embodiments:

1. A method comprising: flattening an event sequence into a feature sequence comprising event prefixes and feature values, the feature sequence comprising a first event prefix and a first set of feature values; generating an attention mask for the feature sequence that comprises first mask indicators to associate the first set of feature values with each other; and providing the feature sequence and the attention mask to a self-attention neural network model to generate an embedding.
2. A method comprising: flattening an event sequence into a feature sequence comprising event prefixes and feature values, the feature sequence comprising a first event prefix, a second event prefix, and a first set of feature values associated with the first event prefix; generating an attention mask for the feature sequence that comprises a mask indicator to associate a first feature value of the first set of feature values with the second event prefix; and providing the feature sequence and the attention mask to a self-attention neural network model to generate an embedding.
3. A method comprising: flattening an event sequence into a feature sequence comprising event prefixes and feature values, the feature sequence comprising a first event prefix, a second event prefix, and a first set of feature values associated with the first event prefix; generating an attention mask for the feature sequence that comprises (i) first mask indicators to associate the first set of feature values with each other and (ii) a second mask indicator to associate a first feature value of the first set of feature values with the second event prefix, wherein the attention mask does not comprise a mask indicator to associate the first feature value with a second feature value of the second event prefix; providing the feature sequence and the attention mask to a self-attention neural network model to generate an embedding, wherein the attention mask causes the self-attention neural network model to determine the embedding based on first attention weights associating the first set of feature values with each other and second attention weights associating the first feature value with the second event prefix; and retrieving a set of user data based on a predicted value derived from the embedding.
4. A method comprising: flattening a multi-dimensional event sequence associated with a user into a feature sequence comprising event prefixes representing events and feature values, wherein different subsets of the feature values are positioned between different event prefixes; generating an attention mask for the feature sequence that comprises (i) first mask indicators to associate first feature values of a first event with each other and (ii) second mask indicators to associate the first feature values with other event prefixes of other events, wherein the attention mask does not comprise a mask indicator to associate the first feature values with at least one feature value of another event; providing, as inputs, the feature sequence and the attention mask to a transformer model to generate a vector representation for the user, wherein the first mask indicators and the second mask indicators cause the transformer model to determine the vector representation based on first attention weights associating the feature values of the first event with each other and second attention weights associating the first feature values with the other event prefixes; predicting a future action category based on the vector representation; and retrieving a set of user-related profile data for display on a web application based on the future action category.
5. A method comprising: flattening an event sequence into a feature sequence comprising event prefixes and feature values, the feature sequence comprising a first event prefix, a second event prefix, and a first set of feature values associated with the first event prefix; generating an attention mask for the feature sequence that comprises (i) first mask indicators to associate the first set of feature values with each other and (ii) a second mask indicator to associate a first feature value of the first set of feature values with the second event prefix, wherein the attention mask does not comprise a mask indicator to associate the first feature value with a second feature value of the second event prefix; providing the feature sequence and the attention mask to a self-attention neural network model to generate a user embedding, wherein the attention mask causes the self-attention neural network model to determine the user embedding based on first attention weights associating the first set of feature values with each other and second attention weights associating the first feature value with the second event prefix; predicting a future action category based on the user embedding; and retrieving a set of user data based on the future action category.
6. The method of any of embodiments 1 to 5, further comprising obtaining events of the event sequence without generating one or more event embeddings of the events, wherein flattening the event sequence comprises flattening the event sequence without generating one or more event embeddings of the events.
7. The method of any of embodiments 1 to 6, wherein the attention mask further comprises a third mask indicator to associate the first feature value with a third feature value of a third event prefix of the feature sequence.
8. The method of embodiment 7, further comprising obtaining an inter-event mapping indication that maps a feature type of a first event type to a feature type of a second event type, wherein generating the attention mask comprises determining the third mask indicator based on the inter-event mapping indication.
9. The method of any of embodiments 7 to 8, wherein generating the attention mask comprises: generating a set of random values; and determining the third mask indicator based on the set of random values.
10. The method of any of embodiments 1 to 9, wherein generating the attention mask comprises: obtaining an attention window of a first event represented by the first event prefix; determining a result indicating that a second event represented by the second event prefix is within the attention window of the first event; and determining the second mask indicator based on the result.
11. The method of embodiment 10, wherein the attention window indicates an event adjacency range of the event sequence.
12. The method of any of embodiments 10 to 11, wherein the attention window is based on a look-back duration of the first event.
13. The method of any of embodiments 1 to 12, further comprising: determining a result indicating that the first feature value is of a target feature type; and determining the second mask indicator based on the result.
14. The method of any of embodiments 1 to 13, wherein flattening the event sequence comprises using a category of a first event represented by the first event prefix as the first event prefix of the feature sequence.
15. The method of any of embodiments 1 to 14, wherein generating the attention mask comprises generating a third mask indicator to associate the first feature value with a third feature value of a third event prefix of the feature sequence.
16. The method of embodiment 15, further comprising: determining whether the first feature value and the second feature value satisfy a set of feature-related criteria; and determining the third mask indicator based on a determination that the set of feature-related criteria is satisfied.
17. The method of any of embodiments 15 to 16, wherein the attention mask is a first attention mask, and wherein the embedding is a first embedding, and wherein the predicted value is a first predicted value, further comprising: generating a second attention mask comprising the first mask indicators, the second mask indicator, and a fourth mask indicator, wherein the second attention mask does not comprise the third mask indicator; providing the feature sequence and the second attention mask to the self-attention neural network model to generate a second embedding; generating a second predicted value based on the second embedding; obtaining a feedback value indicating that the second predicted value is more accurate than the first predicted value; and selecting the second attention mask for use in lieu of the first attention mask based on the feedback value.
18. The method of any of embodiments 1 to 17, further comprising updating the event sequence to comprise a new event associated with an event category, wherein flattening the event sequence comprises using the event category as the first event prefix.
19. The method of any of embodiments 1 to 18, further comprising obtaining a feature-to-event mapping indication that maps a feature type of a first event type to a second event type, wherein generating the attention mask comprises determining the second mask indicator based on the feature-to-event mapping indication.
20. The method of any of embodiments 1 to 19, further comprising filtering the event sequence to remove a set of events indicated to have occurred before a threshold date.
21. The method of any of embodiments 1 to 20, further comprising obtaining a set of event association filters indicating a restricted event type, wherein determining the second mask indicator comprises selecting the second event prefix by ignoring event prefixes associated with the restricted event type.
22. The method of any of embodiments 1 to 21, further comprising: determining a size of an attention window based on a count of neural network layers of the self-attention neural network model; and selecting a set of events within the attention window of a first event associated with the first event prefix, wherein generating the attention mask comprises: determining a result indicating that a second event represented by the second event prefix is within the attention window of the first event; and determining the second mask indicator based on the result.
23. One or more tangible, non-transitory, machine-readable media storing instructions that, when executed by a set of processors, cause the set of processors to effectuate operations comprising those of any of embodiments 1 to 22.
24. A system comprising: a set of processors and a set of media storing computer program instructions that, when executed by the set of processors, cause the set of processors to effectuate operations comprising those of any of embodiments 1 to 22.

What is claimed is:

1. A system for using a sequence of feature values to generate user vectors representing users for pre-retrieving user-related data, the system comprising one or more processors and one or more machine-readable media storing program instructions that, when executed by the one or more processors, cause the one or more processors to perform operations comprising:
flattening a multi-dimensional event sequence associated with a user into a feature sequence comprising event prefixes representing events and feature values, wherein different subsets of the feature values are positioned between different event prefixes;
generating an attention mask for the feature sequence that comprises (i) first mask indicators to associate first feature values of a first event with each other and (ii) second mask indicators to associate the first feature values with other event prefixes of other events, wherein the attention mask does not comprise a mask indicator to associate the first feature values with at least one feature value of another event;
providing, as inputs, the feature sequence and the attention mask to a transformer model to generate a vector representation for the user, wherein the first mask indicators and the second mask indicators cause the transformer model to determine the vector representation based on first attention weights associating the feature values of the first event with each other and second attention weights associating the first feature values with the other event prefixes;
predicting a future action category based on the vector representation; and
retrieving a set of user-related profile data for display on a web application based on the future action category.

2. A method comprising:
flattening an event sequence into a feature sequence comprising event prefixes and feature values, the feature sequence comprising a first event prefix, a second event prefix, and a first set of feature values associated with the first event prefix;
generating an attention mask for the feature sequence that comprises (i) first mask indicators to associate the first set of feature values with each other and (ii) a second mask indicator to associate a first feature value of the first set of feature values with the second event prefix, wherein the attention mask does not comprise a mask indicator to associate the first feature value with a second feature value of the second event prefix;
providing the feature sequence and the attention mask to a self-attention neural network model to generate a user embedding, wherein the attention mask causes the self-attention neural network model to determine the user embedding based on first attention weights associating the first set of feature values with each other and second attention weights associating the first feature value with the second event prefix;
predicting a future action category based on the user embedding; and
retrieving a set of user data based on the future action category.

3. The method of claim 2, further comprising obtaining events of the event sequence without generating one or more event embeddings of the events, wherein flattening the event sequence comprises flattening the event sequence without generating one or more event embeddings of the events.

4. The method of claim 2, wherein the attention mask further comprises a third mask indicator to associate the first feature value with a third feature value of a third event prefix of the feature sequence.

5. The method of claim 4, further comprising obtaining an inter-event mapping indication that maps a feature type of a first event type to a feature type of a second event type, wherein generating the attention mask comprises determining the third mask indicator based on the inter-event mapping indication.

6. The method of claim 4, wherein generating the attention mask comprises:
generating a set of random values; and
determining the third mask indicator based on the set of random values.

7. The method of claim 2, wherein generating the attention mask comprises:
obtaining an attention window of a first event represented by the first event prefix;
determining a result indicating that a second event represented by the second event prefix is within the attention window of the first event; and
determining the second mask indicator based on the result.

8. The method of claim 7, wherein the attention window indicates an event adjacency range of the event sequence.

9. The method of claim 7, wherein the attention window is based on a look-back duration of the first event.

10. The method of claim 2, further comprising:
determining a result indicating that the first feature value is of a target feature type; and
determining the second mask indicator based on the result.

11. The method of claim 2, wherein flattening the event sequence comprises using a category of a first event represented by the first event prefix as the first event prefix of the feature sequence.

12. One or more non-transitory, machine-readable media storing program instructions that, when executed by one or more processors, cause the one or more processors to perform operations comprising:
flattening an event sequence into a feature sequence comprising event prefixes and feature values, the feature sequence comprising a first event prefix, a second event prefix, and a first set of feature values associated with the first event prefix;
generating an attention mask for the feature sequence that comprises (i) first mask indicators to associate the first set of feature values with each other and (ii) a second mask indicator to associate a first feature value of the first set of feature values with the second event prefix, wherein the attention mask does not comprise a mask indicator to associate the first feature value with a second feature value of the second event prefix;
providing the feature sequence and the attention mask to a self-attention neural network model to generate an embedding, wherein the attention mask causes the self-attention neural network model to determine the embedding based on first attention weights associating the first set of feature values with each other and second attention weights associating the first feature value with the second event prefix; and
retrieving a set of user data based on a predicted value derived from the embedding.

13. The one or more non-transitory, machine-readable media of claim 12, wherein generating the attention mask comprises generating a third mask indicator to associate the first feature value with a third feature value of a third event prefix of the feature sequence.

14. The one or more non-transitory, machine-readable media of claim 13, the operations further comprising:
determining whether the first feature value and the second feature value satisfy a set of feature-related criteria; and
determining the third mask indicator based on a determination that the set of feature-related criteria is satisfied.

15. The one or more non-transitory, machine-readable media of claim 13, wherein the attention mask is a first attention mask, and wherein the embedding is a first embedding, and wherein the predicted value is a first predicted value, the operations further comprising:
generating a second attention mask comprising the first mask indicators, the second mask indicator, and a fourth mask indicator, wherein the second attention mask does not comprise the third mask indicator;
providing the feature sequence and the second attention mask to the self-attention neural network model to generate a second embedding;
generating a second predicted value based on the second embedding;
obtaining a feedback value indicating that the second predicted value is more accurate than the first predicted value; and
selecting the second attention mask for use in lieu of the first attention mask based on the feedback value.

16. The one or more non-transitory, machine-readable media of claim 12, the operations further comprising updating the event sequence to comprise a new event associated with an event category, wherein flattening the event sequence comprises using the event category as the first event prefix.

17. The one or more non-transitory, machine-readable media of claim 12, the operations further comprising obtaining a feature-to-event mapping indication that maps a feature type of a first event type to a second event type, wherein generating the attention mask comprises determining the second mask indicator based on the feature-to-event mapping indication.

18. The one or more non-transitory, machine-readable media of claim 12, the operations further comprising filtering the event sequence to remove a set of events indicated to have occurred before a threshold date.

19. The one or more non-transitory, machine-readable media of claim 12, the operations further comprising obtaining a set of event association filters indicating a restricted event type, wherein determining the second mask indicator comprises selecting the second event prefix by ignoring event prefixes associated with the restricted event type.

20. The one or more non-transitory, machine-readable media of claim 12, the operations further comprising:
determining a size of an attention window based on a count of neural network layers of the self-attention neural network model; and
selecting a set of events within the attention window of a first event associated with the first event prefix, wherein generating the attention mask comprises:
determining a result indicating that a second event represented by the second event prefix is within the attention window of the first event; and
determining the second mask indicator based on the result.
